(19) United States
(12) Patent Application Publication
(10) Pub. No.: US 2014/0002367 A1
(43) Pub. Date: Jan. 2, 2014

(54) SYSTEM AND DEVICE WITH THREE-DIMENSIONAL IMAGE DISPLAY

(71) Applicants: Jesper Glückstad, Frederiksberg (DK); Finn Pedersen, Roskilde (DK)

(72) Inventors: Jesper Glückstad, Frederiksberg (DK); Finn Pedersen, Roskilde (DK)

(21) Appl. No.: 13/977,065

(22) PCT Filed: Dec. 21, 2011
(86) PCT No.: PCT/EP2011/073526

§ 371 Date: Sep. 17, 2013

Related U.S. Application Data
(60) Provisional application No. 61/428,302, filed on Dec. 30, 2010.

(30) Foreign Application Priority Data
Dec. 30, 2010 (EP) 10197374.1

(51) Int. Cl. G09G 5/14

(52) U.S. Cl. CPC G09G 5/14
USPC 345/168

(57) ABSTRACT

The present invention relates to a binocular device (44) and a system (40) including a binocular device (44) configured for displaying one or more labels for an input device (2), such as a keyboard or a control panel, comprising a plurality of parts (4, 6) configured for activation and registration by depression. The binocular device (44) is configured for displaying a label of an activation part (4) as a three-dimensional label at the activation part (4).

The present invention relates to a binocular device and a system including a binocular device configured for displaying one or more labels for an input device, such as a keyboard or a control panel, comprising a plurality of parts configured for activation and registration by depression. The binocular device is configured for displaying a label of an activation part or key as a three-dimensional label at the activation part.

Any discussion of prior art throughout this description should not be considered as an admission that such prior art is widely known or forms part of common general knowledge.

International patent publication number WO 2008/065195 discloses a keyboard having labels on the keys that can be changed during operation of the input device.

US application publication number US 2010/0295820 discloses a device where an image in the shape of a button may be projected onto a region so that a button is visible to a user at the region. Further, a raised topography of the region may provide a tactile reinforcement that the region is currently serving as a virtual button. Finally, a user touch directed to the region may be detected, for example as described above, thus allowing the region to provide working button functionality.

Further keyboards are known from the following US patent numbers: U.S. Pat. No. 6,444,888, U.S. Pat. No. 5,818,361, U.S. Pat. No. 4,491,692, and U.S. Pat. No. 5,515,045.

Furthermore, it is known to project light on a flat surface, which light appear as keys of a keyboard.

It is an object of the present invention to provide a system that facilitates use of an input device.

According to the present invention, the above-mentioned and other objects are fulfilled by a system comprising a binocular device and an interrelation system configured for providing an interrelation measure for an interrelation between the binocular device and an input device. The system may comprise the input device. The input device comprises a plurality of activation parts including a first activation part and a second activation part. Each activation part is configured for enabling depression of the activation part by the user, wherein depression of the activation part provides tactile feedback to the user. The input device comprises at least one registration part configured for individual registration of depression of activation parts. The binocular device comprising an imaging system configured for providing a first image to a first eye of the user and configured for providing a second image to a second eye of the user. The first image and the second image are based on the interrelation measure such that the combination of the first image and the second image are perceived as a three-dimensional or a pseudo three-dimensional first object image by the user. The first object image includes a first primary label for the first activation part at the first activation part.

It is a further object of the present invention to provide a binocular device that facilitates use of an input device.

According to the present invention, the above-mentioned and other objects are fulfilled by a binocular device comprising an interrelation system configured for providing an interrelation measure for an interrelation between the binocular device and an input device. The input device comprises a plurality of activation parts including a first activation part and a second activation part. Each activation part is configured for enabling depression of the activation part by the user, wherein depression of the activation part provides tactile feedback to the user. The input device comprises at least one registration part configured for individual registration of depression of activation parts. The binocular device comprises an imaging system configured for providing a first image to a first eye of the user and configured for providing a second image to a second eye of the user, wherein the first image and the second image are based on the interrelation measure such that the combination of the first image and the second image are perceived as a three-dimensional or a pseudo three-dimensional first object image by the user. The first object image includes a first primary label for the first activation part at the first activation part.

The present invention provides one or more of the following advantages: a more versatile indication of a label for an activation part of the input device, an improved access, an improved indication of how to use the input device, an improved and more intuitive indication of options of use of the input device.

It is furthermore an advantage of the present invention that the input device may be operated by the user in at least substantially the same way as a computer keyboard is operated. For example, a specific type of tactile feedback experienced by the user during use of a particular computer keyboard may be provided by the input device according to the present invention.

It is furthermore an advantage of the present invention that the system and/or the binocular device may be used in combination with existing input devices, such as existing keyboards.

### BRIEF DESCRIPTION OF THE DRAWINGS

The above and other features and advantages of the present invention will become readily apparent to those skilled in the art by the following detailed description of exemplary embodiments thereof with reference to the attached drawings, in which:

FIG. 1 schematically illustrates a top view of a system according to the present invention and a user,

FIG. 2 schematically illustrates the binocular device illustrated in FIG. 1 with the eyes and ears of the user,

FIG. 3 schematically illustrates a side view of a part of an input device,

FIG. 4 schematically illustrates a system according to the present invention, and

FIG. 5 schematically illustrates a binocular device according to the present invention.

The figures are schematic and simplified for clarity, and they may merely show details which are essential to the understanding of the invention, while other details may have been left out, e.g. for reasons of simplicity. Throughout, the same reference numerals are used for identical or corresponding parts.

It should be noted that in addition to the exemplary embodiments of the invention shown in the accompanying drawings, the invention may be embodied in different forms and should not be construed as limited to the embodiments set forth herein. Rather, these embodiments are provided so that this disclosure will be thorough and sufficient, and will fully convey the concept of the invention to those skilled in the art.

### DETAILED DESCRIPTION

The present invention provides a binocular device and a system comprising a binocular device configured for providing a user with a three-dimensional image containing at least one label of an activation part of an input device, such that the at least one label is perceived to be present at the respective activation part. The input device may for instance be a keyboard, such as a computer keyboard. The activation part may for instance be a key of a/the keyboard.

The input device may be any device, such as a control panel (e.g. for an elevator, in a car, etc.) or a keyboard, such as a computer keyboard, comprising a plurality of activation parts in form of keys. The input device may form part of another device, such as a computer (e.g. a laptop computer), a telephone, a mobile phone, a tablet computer, etc.

The binocular device and/or the system according to the present invention may be configurable for enabling use with a plurality of different input devices, such as a plurality of different keyboards having different layout of keys. For instance, the binocular device and/or the system may preconfigured to operate with specific input devices and/or the binocular device and/or the system may comprise an image recognition system for identifying an input device in terms of location of activation parts. For instance the locations of the keys of a keyboard may be detected by means of a camera included in the system and/or the binocular device.

A computer keyboard may be a typewriter keyboard, which uses an arrangement of buttons or keys, to act as mechanical levers, electronic switches, or for activation of any suitable registration part.

The input device may for instance be used with a computer, an electronic game, a toy, a musical instrument, a money dispenser, a sales terminal, or another terminal, or electronic device, such as a telephone, etc.

The input device may be used in connection with applications for a computer for learning, games, graphical production, music production, typing of mathematical formulas or equations, or for any other purpose where a large number (such as above 50 or above 100) of symbols and/or characters needs to be accessible for typing in.

The activation parts represent respective parts of the input device, which parts the user may actuate individually, e.g. by depression by means of a finger of the user.

The activation part may comprise a surface part, such as the upper surface part. The activation part may be configured to be depressed directly by the user, or may be configured to be depressed through an overlaying part, such as a cover, such as a flexible cover. A depression of the activation part may generate a motion of the activation part, which motion may be transferred to the registration part (or a part thereof), e.g. by direct motion of the registration part (or a part thereof) via a rigid connection between activation part and the registration part. The activation part may be moveably or communicately connected with the registration part.

The upper surface part of an activation part, such as the cap part of a key, may be substantially squared, such as squared with rounded edges, such as a shape of a key cap of a computer keyboard. The dimensions of an upper surface part of an activation part may have a first length from 1 to 2 cm and a second length from 1 to 2 cm.

The tactile feedback relates to how it feels to depress an activation part. For example, whether a “click” is generated by an activation part when the activation part is depressed by the user and how the “click” may feel and/or sound. Tactile feedback may relate to the length of linear displacement of the activation part when depressed by the user. The input device may comprise a dome and/or a scissor-switch element for each activation part, e.g. for each key, for generating the tactile feedback to be provided to the user by the activation part, i.e. via the activation part. The input device may comprise a guide for each activation part for guiding the depression of the respective activation part substantially along a respective linear axis. The guide may be provided by means of the scissor-switch and/or the dome. Thus, the activation part may be arranged for a linear motion when activated.

The linear motion or travel distance of the activation part from a position in rest to a position of registration may for instance be from 1 to 3 mm such as about 2 mm.

The registration part may comprise an electronic circuit or may be configured to short-circuit an electronic circuit. Alternatively or in combination, the registration part may be configured to influence propagation of light towards a light detector for enabling registration of an activation of the activation part.

The combination of the first image and the second image are presented such that a user may perceive the combination as a three-dimensional or a pseudo three-dimensional first object image including a first primary label for the first activation part at the first activation part. In this context, “at an activation part” may include: within, under, above, around, next to the activation part, or any combination of the aforementioned prepositions, such as above and within the activation part. Thus, a respective image may appear to be within and/or around a volume of a respective activation part, such as being above and/or under the respective activation part.

The imaging system may comprise at least one image displaying part, such as a first image displaying part for the first eye and a second image displaying part for the second eye.

A respective image displaying part refers to a part of the input device that is configured to display an image to the user. Display of an image may for instance be by generation of the image information to be displayed to the user, or it may be by being configured for imaging of light containing image information, which light is projected onto the image displaying part from a source that may generate image information to be displayed.

Individual images may be displayed at each activation part. Alternatively or in combination, one or a limited number of images comprising at least one label for each activation part may be displayed. The image at an activation part may display one or more labels associated with the activation part. Thus, when looking at a respective activation part, the user may be able to see an image displayed to the user, which image may represent one or more labels of the respective activation part.

Perception of an image as a three-dimensional or pseudo three-dimensional first image is an essential part of the present invention. Numerous methods of generation of so-called three-dimensional images exist. References to three-dimensional images are however often only a pseudo three-dimensional image in form of a stereoscopic image. A three-dimensional image may for instance be a holographic image.

In the context of the present application a stereoscopic image comprises two images, i.e. a first image for a first eye and a second image for a second eye of the user.

Throughout the present description, the abbreviation 3D is to be interpreted as three-dimensional or pseudo three-dimensional, where pseudo three-dimensional covers any method or technique of providing something to a user such that the user gets an impression or illusion of viewing something in three dimensions. Pseudo three-dimensional techniques may for instance include any stereoscopic method as known in the art of 3D image display. Thus, any method of generation of a 3D image or of generation of an illusion of a 3D image may be included in the present invention.

The binocular device may be configured to provide the first object image as a dynamic first object image, i.e. e.g. such that the object image may be altered during and/or before user operation of the input device. The alteration may include a modification of one or more labels associated with a respective activation part. Thus, an improved versatility is provided.

A combination of displaying in 3D and displaying dynamic may be referred to as displaying in four dimensions, i.e. abbreviated “4D”.

For known computer keyboards, several symbols (labels) may be provided for a single key, e.g. in the row normally displaying the numbers 1-9 and 0 (primary labels), where one or two other symbols (labels) are also printed on a top part (cap part) of the respective key. For instance, on a computer keyboard with a Danish layout, the key comprising the label “7” as the primary label furthermore comprises the labels “/” and “{” as secondary and tertiary labels.

The input device may be a keyboard, e.g. a computer keyboard, with a plurality of keys. The plurality of keys may include a first key and a second key. The first key may have a first cap part. The second key may have a second cap part. The first activation part may at least partly form the first cap part or the first cap part may include the first activation part. The second activation part may at least partly form the second cap part or the second cap part may include the second activation part.

A 3D image may enable that a plurality of labels of an activation part are presented at different heights or levels, e.g. a primary label may be displayed at a primary level and a secondary label may be displayed at a secondary level. Thus, in improved user friendliness may be provided.

The input device as configured for dynamic display, e.g. in form of a keyboard (a dynamic display keyboard), such as a computer keyboard, may be provided such that by depressing a modifier key (activation part), such as a “ctrl”, “shift, or “alt” key, the labels composing the plurality of labels may change position in 3D such that the label (i.e. the active label) that corresponds to the signal that will be generated if the respective key is depressed, is highlighted and/or is positioned above the other label(s) of the respective key. Thus, an indication of the selection, e.g. by means of a modifier key, of a label (the active label) of a key or an activation part may be improved by the present invention.

The object image may include a second primary label for the second activation part. The object image may include a first secondary label for the first activation part. The object image may include a second secondary label for the second activation part.

The input device configured for displaying the first image dynamically may for instance be configured such that one or more images or labels associated with respective activation parts (or keys) may be altered or amended in response to events occurring in a program controlled using the input device. For instance, if a user is expected to activate one activation part out of a limited group of the plurality of activation parts, the images related to that particular limited group may be highlighted and thereby enabling an improved interaction. The highlighting may for instance involve that a part of the respective image appears to move, and/or by having one or more labels of the highlighted activation parts appearing to be moved on top of the respective activation parts.

One or more labels may be adapted or amended during operation of the input device, e.g. in order to display one or more symbols or icons as a label that indicates a current function of respective activation part of key of the input device. Thus, dynamically displaying labels may enable change between different letters and/or symbols and/or short-cuts.

Provision of a binocular device configured for displaying dynamically may enable that symbols on a computer keyboard may be adapted, e.g. according to a type of keyboard layout a user is used to, e.g. a specific keyboard layout as utilized in a specific country. Thus, the binocular device may be adapted to present key labels according to a specific standard and/or may be configured to present a group of labels that are used with a particular computer program.

The binocular device with dynamical display or projection of labels may eliminate or reduce the need for several input devices, such as several keyboards, and/or may eliminate or reduce the need for a user to remember short-cut combinations when using an input device. Thus, the time of adaptation for a user to a new computer program may be reduced. Furthermore, the use of a computer mouse (or a similar device) may be reduced or eliminated since the use of drop down menus may not be needed or may be less needed by the user.

The imaging system may comprise at least one display, such as a liquid crystal display (LCD), a plasma display panel, a light-emitting diode (LED) display, an organic light-emitting diode (OLED) display, or a liquid crystal on silicon (LCoS) display.

The imaging system may comprise a light source for illumination the at least one display. Alternatively or in combination, the at least one display may depend on or may be configured to employ ambient light for being visible for the user.

The at least one display may be at least partly transparent, such that at least part of the input device may be visible through the at least one display.

The imaging system may comprise at least one light emitting part, such as at least three lasers, such as at least three diode lasers, including a first light emitting part, such as a first laser, such a first diode laser, for projection of at least a part of the first image to the first eye and/or for projection of at least a part of the second image to the second eye and/or for emitting light onto or towards the at least one light scattering part for displaying the first image and/or the second image.

The imaging system may comprise at least one light scattering (diffusing) part including a first light scattering part for scattering incident light. The at least one light scattering part may comprise at least one diffuser including a first diffuser. The at least one light scattering part may comprise a polymer structure. The at least one light scattering part may enable imaging of the first image by having at least one light source, such as a display, a projector, or another light emitter, illuminating the at least one light scattering part (or parts thereof) with light for imaging.

The input device may comprise at least one light redirecting structure, such as a plurality of light redirecting structures, such as a plurality of mirrors or one or more micro-mirror devices, for redirecting light from the at least one light emitting part into the first eye and/or the second eye and/or onto the at least one light scattering part.

The at least one light scattering part may be combined with the at least one display, such at an LCoS display. Thus, by means of rear-projection, e.g. by use of the at least one light redirecting structure, light from the at least one display may be projected on the at least one light scattering part for display of the first image. Provision of such a solution may reduce weight of the binocular device compared to a binocular device comprising another display.

The imaging system may comprise at least one optical element or at least one optical structure for focusing light onto the at least one light scattering part or for focusing light on an eye of the user.

The at least one optical structure may be configured for projection from the at least one display onto the at least one light scattering part.

The at least one optical structure may be in form of a transparent polymer layer being provided in the optical path between the at least one display and the at least one light scattering part.

The at least one light scattering part may be configured to at least partly transmit incident light or may be configured to at least partly reflect incident light.

By means of a light transmitting and scattering part, the binocular device may be configured for rear projection (at any convenient angle of incidence) of light from at least one light emitting part onto the at least one light scattering part.

By means of a light reflecting and scattering part, the binocular device may be configured for front projection (at any convenient angle of incidence) of light from at least one light emitting part onto the at least one light scattering part.

The at least one optical element or at least one optical structure may be configured for focusing light from the at least one light emitting part onto the at least one light scattering part and/or on an eye (a pupil) of a user.

The plurality of light redirecting structures may be configured for redirecting light from the at least one light emitting part onto the at least one light scattering part and/or on an eye (a pupil) of a user.

The at least one imaging system may be configured to displaying to the user the object image in form of a stereoscopic image or a holographic image, e.g. a holographic image for each eye. The first image may be a holographic image. The second image may be a holographic image. Display of a stereoscopic image or a holographic image is well known in the art of displaying images in 3D.

A holographic image may be a dynamic computer generated holographic image. The holographic image may for instance be provided by one or more holographic structures to be illuminated by the at least one light emitting part, such as a laser source, such as three laser sources, such as an RGB laser.

The imaging system may comprise at least one at least partly transparent part, such that the input device may be at least partly seen by the user through the at least one at least partly transparent part. The at least one at least partly transparent part may comprise a partly or at least partly reflective mirror for reflecting light from the first light emitting part into the first eye of the user. The at least one at least partly transparent part may comprise a first at least partly transparent part for the first eye and a second at least partly transparent part for the second eye.

The binocular device may be head-mountable, such as being helmet-mountable. Thus, it may be ensured that the binocular device remain fixed in relation to the head of the user. Furthermore, it may be ensured that the binocular device remain at least substantially fixed in relation to the eyes of the user. Furthermore, it may be ensured that the binocular device remain at least substantially fixed in relation to the apertures of eyes of the user, i.e. the pupils.

The interrelation measure may comprise an orientation of the binocular device in relation to an orientation of the input device, i.e. an interrelated orientation. The interrelation measure may comprise a position of the binocular device in relation to a position of the input device, i.e. an interrelated position. Generally, the distance between the binocular device and an activation part (and/or the input device) may determine the size of a corresponding label. Generally, the orientation of the binocular device in relation to the input device and in particular in relation to a specific activation part of the input device may determine whether and where in the first and second image a corresponding label is presented.

The interrelation system may comprise a first communication device at the input device and a second communication device at the binocular device. The first and second communication device may be configured for communication of information for provision of the interrelation measure. The communication may be wireless, such as radio frequency communication. The wireless communication may for instance be at the 2.4 GHz region.

The interrelation system may be adapted such that a direction and/or a distance between the input device and the binocular device is provided, e.g. by means of communication between respective communication devices at the input device and the binocular device. Information about a direction and/or a distance may be combined with information from one or more sensors at the binocular device for providing an inclination of the binocular device in relation to a horizontal surface. Thus, if the input device is stationary, or at least is situated on a horizontal surface and/or a known surface, an orientation and a position of the binocular device in relation to the input device can be estimated.

The interrelation system may comprise a recognition system configured for recognising an input device, e.g. by means of image recording e.g. in the viewing direction of the binocular device such that an input device, such as a keyboard, may be recognised by the recognition system. Furthermore, the direction and/or distance to the input device may be recognised, whereby an interrelation measure may be provided. Alternatively or additionally, the recognition system may comprise at least one recognition communication unit configured for recognising an input device comprising one or more corresponding communication units forming part of the input device.

The input device according to the present invention may comprise a light-induced shape-memory polymer display screen as disclosed in US 2010/0295820 and/or the input device according to the present invention may comprise a topography-changing layer as disclosed in US 2010/0295820. The input device may include a display screen having a topography-changing layer including a light-induced shape-memory polymer. The input device may further include an imaging engine configured to project visible light onto the display screen, where the visible light may be modulated at a pixel level to form a display image thereon, i.e. to form at least the first image. The display device may further include a topography-changing engine configured to project agitation light of an ultraviolet band towards the display screen, where the agitation light is modulated at a pixel level to selectively change a topography of the topography-changing layer. Thus, activations parts that enable depression may be provided.

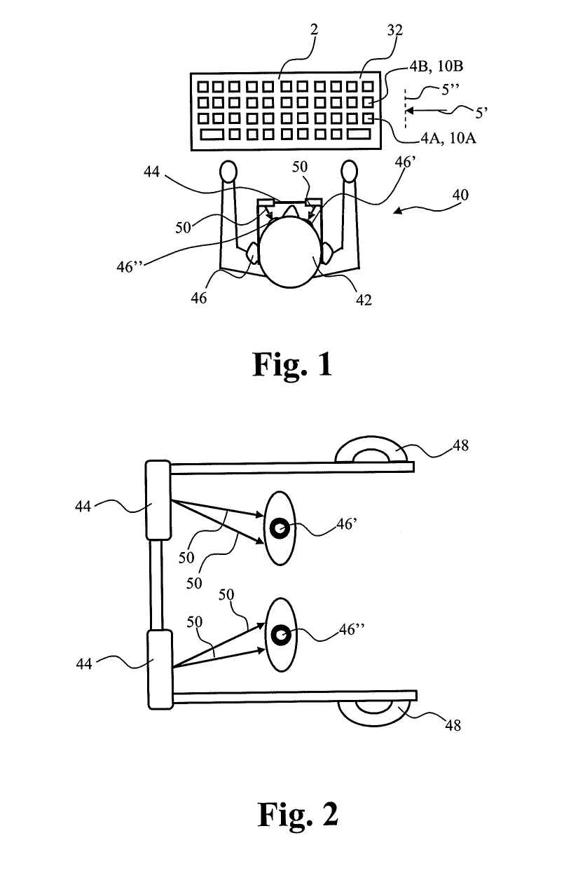

FIG. 1 schematically illustrates a top view of a system 40 according to the present invention and a user 42. The system 40 comprises a binocular device 44 and an interrelation system configured for providing an interrelation measure for an interrelation between the binocular device 44 and an input device 2.

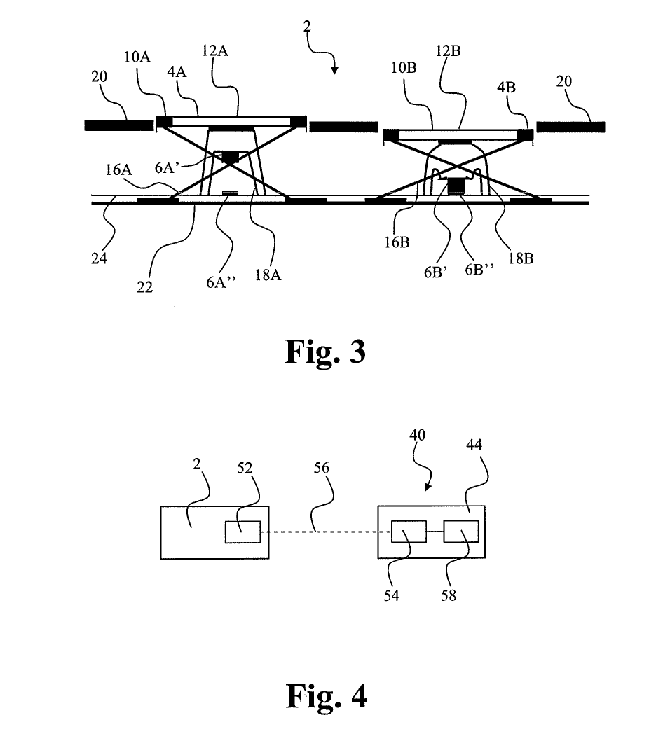

FIG. 3 schematically illustrates a side view of a part of the input device 2 illustrated in FIG. 1. The side view is seen from the dotted line 5″ in the direction of the arrow 5′ as illustrated in FIG. 1. The input device 2 comprises a plurality of activation parts 4 including a first activation part 4A and a second activation part 4B. The input device 2 comprises a plurality of registration parts 6 including a first registration part 6A and a second registration part 6B.

The input device 2 is a keyboard 32 with a plurality of keys 10 including a first key 10A and a second key 10B. The first key 10A has a first cap part 12A formed by the first activation part 4A and the second key 10B has a second cap part 12B formed by the second activation part 4B.

The input device 2 comprises a plurality of scissor-switches 16 including a first scissor-switch 16A and a second scissor-switch 16B.

The input device 2 comprises a plurality of domes 18 including a first dome 18A and a second dome 18B.

The input device has a keyboard top 20 and a keyboard bottom 22 forming part of a housing for the keyboard.

The input device 2 furthermore comprises a printed circuit board (PCB) 24.

Each activation part 4 is configured for enabling depression of the activation part by the user. The input device 2 is configured such that depression of the activation part 4 provides tactile feedback to the user.

The input device comprises a scissor-switch 18 and a dome 16 for each activation part for generation of tactile feedback during depression of the respective activation part 4.

The first activation part 4A is illustrated in a non-depressed state and the second activation part 4B is illustrated in a depressed state. For depression of an activation part 4 a user may for instance use a finger, which however is not illustrated in FIG. 3.

The plurality of registration parts 6, 6A, 6B are configured for individual registration of depression of the activation parts 4, 4A, 4B. The first registration part 6A is configured for registration of depression of the first activation part 4A. The second registration part 6B is configured for registration of depression of the second activation part 4B.

When an activation 4 part is depressed to a certain level, a first part 6A′, 6B′ of the corresponding registration part 6 comes into contact with a corresponding second part 6A″, 6B″ of the registration part 6 on the PCB 24. The contact between a first part and a second part of a registration part 6 provides that the depression of the activation part 4 may be registered electronically via the PCB. This may for instance be enabled by the first part 6A′, 6B′ having en electric conducting surface that, when in contact with the second part 6A″, 6B″, short-circuits an electrical circuit formed by the second part 6A″, 6B″.

The travel distance of an activation part 4 from a position in rest to the position of registration is around 2 mm. In general, the travel distance may be selected in a range from e.g. 3 mm to e.g. 1 mm.

FIG. 2 schematically illustrates the binocular device 44 illustrated in FIG. 1 and illustrates the eyes 46 and ears 48 of the user 42. The binocular device 44 comprises an imaging system configured for providing a first image to a first eye 46′ of the user and configured for providing a second image to a second eye 46″ of the user. The provision of the images is illustrated by means of the arrows 50 in FIGS. 1 and 2 directing from the binocular device 44 to the respective eyes 46 of the user 42. The first image and the second image are based on the interrelation measure such that the combination of the first image and the second image are perceived as a three-dimensional or a pseudo three-dimensional first object image by the user. The first object image includes a first primary label for the first activation part 4A at the first activation part 4A.

The binocular device 44 is head-mountable. This is achieved by the binocular device being configured for supporting on at least the ears 48 of the user. Generally, however, any other suitable method of enabling the binocular device to be head-mountable may be provided.

FIG. 4 schematically illustrates a system 40 according to the present invention. The system 40 comprises a binocular device 44 and an interrelation system configured for providing an interrelation measure for an interrelation between the binocular device and an input device 2.

The interrelation system comprises a first communication device 52 at the input device 2 and a second communication device 54 at the binocular device 44. The first and second communication devices (52 and 54) are configured for wireless communication of information for provision of the interrelation measure. The wireless communication is illustrated by means of the dotted line 56.

The input device 2 illustrated in FIG. 4 comprises a plurality of activation parts including a first activation part and a second activation part. Each activation part is configured for enabling depression of the activation part by the user, wherein depression of the activation part provides tactile feedback to the user. The input device 2 comprises at least one registration part configured for individual registration of depression of activation parts.

The binocular device 44 illustrated in FIG. 4 comprises an imaging system 58 configured for providing and/or generating a first image to a first eye of the user and configured for providing and/or generating a second image to a second eye of the user. The first image and the second image are based on the interrelation measure such that the combination of the first image and the second image are perceived as a three-dimensional or a pseudo three-dimensional first object image by the user. The first object image includes a first primary label for the first activation part at the first activation part. Furthermore, for the embodiment illustrated in FIG. 4, the interrelation measure is provided to the imaging system 58 from the second communication device 54.

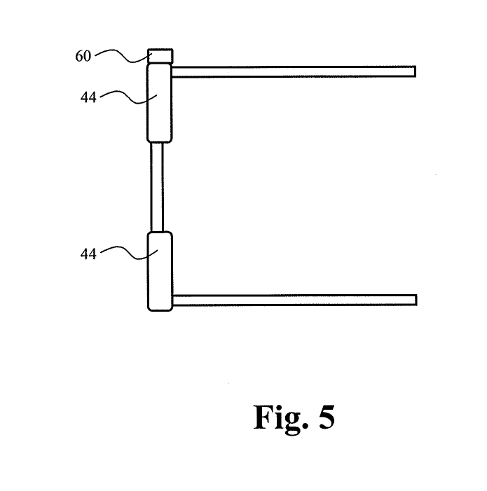

FIG. 5 schematically illustrates a binocular device 44 according to the present invention. The binocular device comprises an interrelation system 60 configured for providing an interrelation measure for an interrelation between the binocular device and an input device (not illustrated in FIG. 5).

The interrelation system 60 comprises a recognition system configured for determining a relative direction and a relative distance to the input device.

The input device (not illustrated in FIG. 5) comprises a plurality of activation parts including a first activation part and a second activation part. Each activation part is configured for enabling depression of the activation part by the user, wherein depression of the activation part provides tactile feedback to the user. The input device comprises at least one registration part configured for individual registration of depression of activation parts.

The binocular device 44 illustrated in FIG. 5 comprises an imaging system configured for providing a first image to a first eye of the user and configured for providing a second image to a second eye of the user. The first image and the second image are based on the interrelation measure from the interrelation system 60 such that the combination of the first image and the second image are perceived as a three-dimensional or a pseudo three-dimensional first object image by the user. The first object image includes a first primary label for the first activation part at the first activation part.

1. A system comprising:
a binocular device;
an input device;
and an interrelation system configured for providing an interrelation measure for an interrelation between the binocular device and the input device,
wherein the input device includes:
a plurality of activation parts including a first activation part and a second activation part, each activation part being configured to enable depression of the activation part by a user, wherein depression of the activation part provides tactile feedback to the user, and
at least one registration part configured for individual registration of depression of activation parts,
the binocular device includes an imaging system configured to provide a first image to a first eye of the user and configured to provide a second image to a second eye of the user,
wherein the first image and the second image are based on the interrelation measure such that the combination of the first image and the second image are perceived as a three-dimensional or a pseudo three-dimensional first object image by the user, the first object image including a first primary label for the first activation part at the first activation part.

2. The system according to claim 1, wherein the interrelation measure comprises an orientation of the binocular device in relation to an orientation of the input device.

3. The system according to claim 1, wherein the interrelation measure comprises a position of the binocular device in relation to the input device.

4. The system according to claim 1, wherein the input device is a keyboard with a plurality of keys including a first key and a second key, the first key including a first cap part and the second key including a second cap part, wherein the first activation part forms the first cap part and the second activation part forms the second cap part.

5. The system according to claim 1, wherein the binocular device is configured to provide the first object image as a dynamic first object image.

6. The system according to claim 1, wherein the imaging system comprises at least one display.

7. The system according to claim 1, wherein the imaging system comprises at least one light emitting part that projects at least a part of the first image to the first eye.

8. The system according to claim 7, wherein the imaging system comprises at least one light redirecting structure that redirects light from the at least one light emitting part into the first eye.

9. The system according to claim 1, wherein the imaging system comprises an at least partly transparent part, such that the input device may be at least partly seen by the user through the at least partly transparent part.

10. The system according to claim 17, wherein the at least partly transparent part comprises a partly reflective mirror for reflecting light from the first light emitting part into the first eye of the user.

11. The system according to claim 1, wherein the imaging system is configured to provide the first object image as a stereoscopic image.

12. The system according to claim 1, wherein the first image is a holographic image.

13. The system according to claim 1, wherein the binocular device is head-mountable.

14. The system according to claim 7, wherein the interrelation system comprises:
a first communication device at the input device; and
a second communication device at the binocular device, the first and second communication devices being configured to communicate information for provision of the interrelation measure.

15. The system according to claim 1, wherein the binocular device comprises the interrelation system.

16. The system according to claim 1, wherein the system comprises the input device.

17. The system according to claim 7, wherein the imaging system comprises an at least partly transparent part, such that the input device may be at least partly seen by the user through the at least partly transparent part.
